(19) United States
(12) Patent Application Publication
(10) Pub. No.: US 2003/0083976 A1
(43) Pub. Date: May 1, 2003

(54) Financial market transaction device and method of use

(76) Inventor: Robert McLister, West Bloomfield, MI (US)

Correspondence Address: WILLIAM C. FLYNN, ATTORNEY AT LAW, 110110 FRIENDSHIP LANE NO., CHASKA, MN, 55318, US

(21) Appl. No.: 10/027,878

(22) Filed: Oct. 26, 2001

(51) Int. Cl. G06F 17/60

(52) U.S. Cl. 705/37

(57) ABSTRACT

A financial market transaction device is provided with a computer, including a monitor, and keyboard, the monitor includes a screen displaying a symbol for a tradable, a bid side and an offer side, the bid side including a list of bid montage rows, each bid montage row including a bid market participant, a bid price and a bid routing character, the offer side including a list of offer montage rows, each offer montage row including an offer market participant, an offer price and an offer routing character; routing character keys each corresponding with a member selected from the group consisting of bid routing characters and offer routing characters; and quantity keys associated with different numbers of units to be traded, such that each routing character key in conjunction with each quantity key define a transaction of a determined number of units of a determined tradable from a determined market participant at a determined price; and a method of use is provided with the steps of describing a tradable in a montage; showing in the montage various market participants for the tradable, prices per unit from each market participant, and routing characters in a matrix, each routing character associating with one market participant and one price; coordinating each routing character with a routing character key; providing quantity keys, each key associated with a predetermined quantity; and defining a transaction including the tradable, market participant, market participant's price per unit and the quantity via pressing a routing character key and a quantity key.

### FIELD OF THE INVENTION

The present invention relates to devices and methods for use in the financial markets and more particularly for use in quickly initiating purchases and sales from a montage.

### BACKGROUND OF THE INVENTION

Today's financial markets offer countless trading opportunities. Common tradables include stocks, bonds, options and commodities. Traders know that the difference between a profit and loss often depends on seconds or even fractions of a second. Once the opportunity is gone, it's gone forever. Minimizing order entry delays is crucial to seizing investment opportunities and avoiding missed executions.

Due to this critical need for speed, most traders now enter orders electronically. Currently, traders enter electronic orders in one of several ways. Traders may type orders into an order entry screen with a keyboard, use a mouse driven point-and-click interface, or use a mouse-driven interface in conjunction with keyboard entry. FIGS. 1 and 2 show prior art versions of systems allowing for entry of electronic orders. Electronic orders are generally performed with reference to montage windows or level II windows, which provide the supply and demand information for a given tradable.

Current order entry systems, however, are unnecessarily cumbersome and time consuming. That is in large part because every transaction typically needs to include identification of the tradable, order destination, price, and quantity. Current systems are also generally not fully intuitive and require a substantial number of keystrokes, mouse clicks, or other steps to implement orders. This frequently results in precious seconds being spent to configure and transmit orders to the appropriate destinations.

What is needed is a system with a minimum number of clicks or keystrokes to effectuate a transaction. Further, the steps should be repetitive from transaction to transaction to provide for an intuitive response as the user learns the system. Lastly, the system should be highly flexible, allowing for a wide variety of transaction types to be entered with a limited number of keystrokes or mouse clicks.

### SUMMARY OF THE INVENTION

A financial market transaction device is provided with a computer screen, routing character keys, and quantity keys.

The computer screen has a quotes montage that may show at least a symbol for a tradable, a bid side and an offer side. The bid side may include a list of bid montage rows. Each bid montage row may include a bid market participant, a bid price, the quantity bid for, and a bid routing character. The offer side may include a list of offer montage rows. Each offer montage row may include an offer market participant, an offer price, the quantity being offered, and an offer routing character. A montage is a software window that facilitates financial market transactions, showing current bids and offers of market participants in a chosen stock, bond, option or future. Routing character keys correspond with bid routing characters and offer routing characters.

Quantity keys are each associated with different numbers of units of the selected tradable to be traded. The term “unit” is intended to refer to portions of tradables, typically shares or contracts. Each quantity key, when used in conjunction with each routing character key, defines a transaction of a specific number of units of a specific tradable with a specific market participant at a specific price.

The method of processing financial market information is provided with the steps of identifying a tradable in a montage; showing in the montage various market participants for the tradable, prices per unit from each market participant, and routing characters in a matrix, each routing character associating with one market participant and one price; coordinating each routing character with a routing character key; providing quantity keys, each key associated with a predetermined quantity; and defining a transaction including the market participant, the market participant's price per unit and the quantity via pressing a routing character key and a quantity key.

Advantageously, this device and method provide significantly quicker order entry times when buying or selling stocks, bonds, futures and other tradables.

Another advantage is that a single routing character can be used to identify both the desired order destination and the desired transaction price, eliminating the need for an additional step.

As yet another advantage, the present system reduces transaction times substantially over pre-existing systems, allowing one to complete transactions before the opportunity is gone.

Also advantageously, the system is intuitive with a fast learning curve, since a particular routing character may always associate with a specific row, making the sequence of steps repetitive and familiar.

As still yet another advantage, the present system can be incorporated into virtually any existing montage window produced by a wide variety of vendors.

### DESCRIPTION OF THE DRAWINGS

FIG. 1 shows a montage window known in the prior art and available from the REDI Plus web site;

FIG. 2 shows a montage window known in the prior art and available from the Hold Brothers web site;

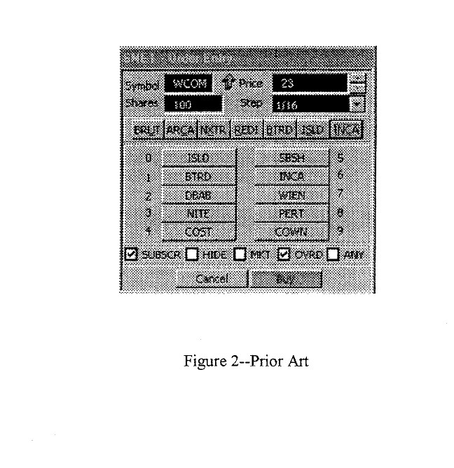

FIG. 3 shows a montage window known in the prior art and available from the Momentum Securities web site;

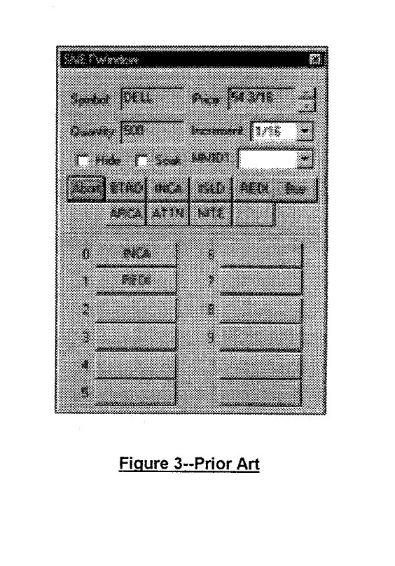

FIG. 4 shows a montage window illustrating the present invention;

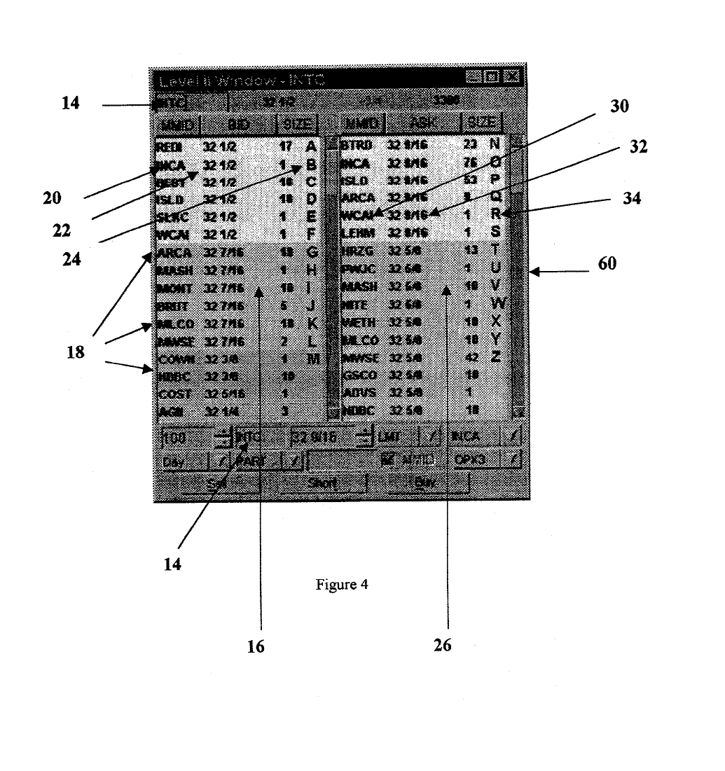

FIG. 5 shows a montage window illustrating the present invention; and

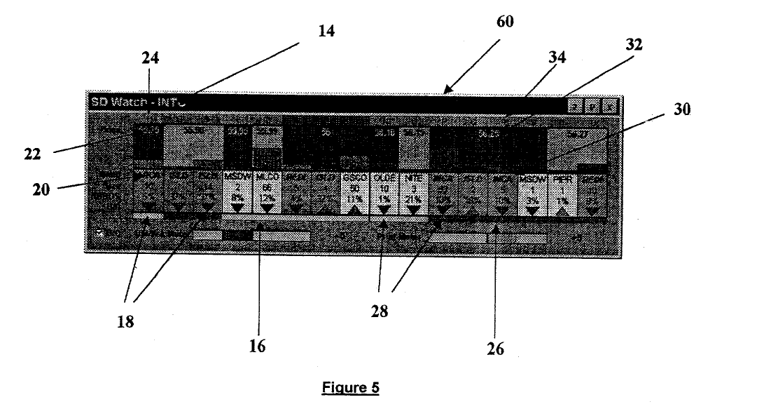

FIG. 6 shows the computer system of the present invention.

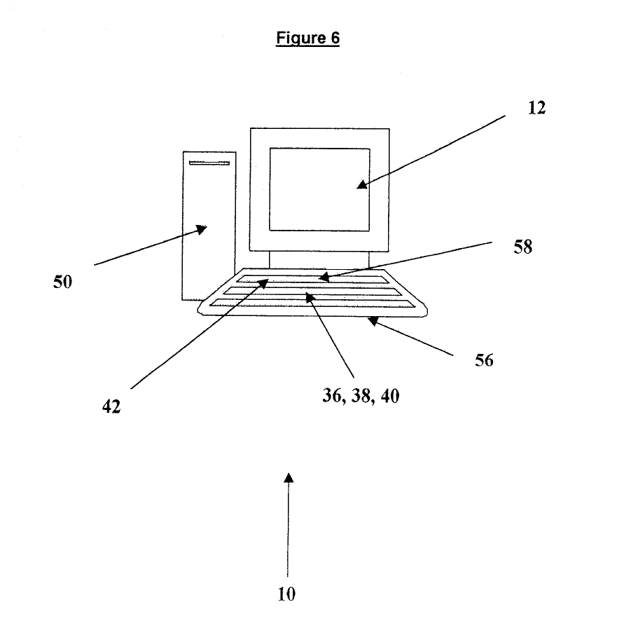

### DETAILED DESCRIPTION

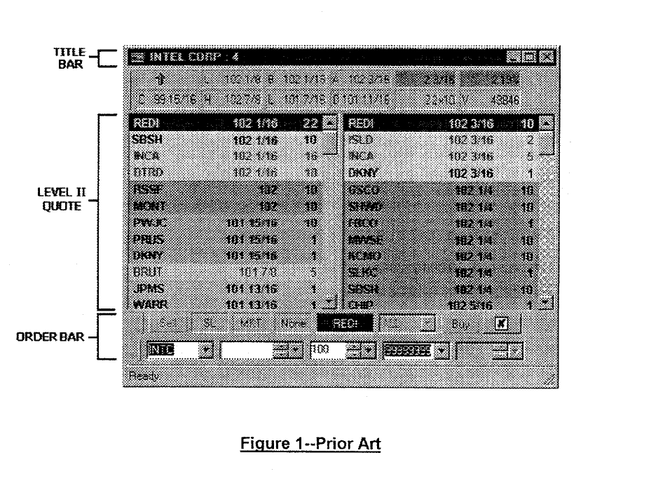

This financial market transaction device 10 is provided with a computer screen 12, routing character keys 36 and quantity keys 42. FIG. 1 shows a computer 50, with a monitor 52, tower or other CPU 54, keyboard 56 and keyboard keys 58 in operable communication with a computer screen 12. The computer screen 12 may display a montage screen or level 11 window 60.

The computer screen 12 may display a symbol 14 for a tradable, a bid side 16 and an offer side 26. The symbol 14 may be part of the montage 60 or not, although it is preferable to have a symbol 14 associated with the montage 60 in some manner or form. The bid side 16 preferably includes a list of bid montage rows 18. Throughout, the montage rows 18 will be referred to as “rows” for convenience, it being understood that while rows are conventionally arranged horizontally, the word row as used is intended to include vertical rows, sometimes referred to as columns. Each bid montage row 18 may include a bid market participant 20, a bid price 22 of the bid market participant 20 and a corresponding bid routing character 24. A bid market participant 20 is a market maker, Electronic Communication Network (ECN), crossing network, exchange or other order destination that is willing to purchase units of a tradable at a certain price, referred to as their bid price 22. The term “unit” is intended to refer to quantities of tradable including both whole numbers and fractional quantities. The bid routing character may be a character assigned to a particular montage row 18, containing the identification of a bid market participant 20 and the bid market participant's bid price 22, or may be an on screen key or button linked into a specific row containing the identification of a bid market participant 20 and the bid market participant's bid price 22.

The offer side 26 may include a list of offer montage rows 28. The term “row” is intended to include both horizontal and vertical rows, sometimes referred to as columns. Each offer montage row 28 may include an offer market participant 30, an offer price 32 of the market participant 30 and a corresponding offer routing character 34. An offer market participant 30 is a market maker, Electronic Communication Network (ECN), crossing network, exchange or other order destination that is willing to offer units of a particular tradable at a certain price, referred to as their offer price 32. The offer routing character 34 may be a character assigned to a particular montage row 28, containing the identification of a offer market participant 30 and the offer market participant's offer price 32, or may be an on screen key or buttonlinked to a specific row, containing the identification of a offer market participant 30 and the offer market participant's offer price 32.

Bid routing characters 24 and offer routing characters 34 may in combination be referred to as routing characters which are associated with routing character keys 36. Routing character keys 36 are preferably keyboard keys with letters, but may be associated with other keyboard keys or on screen keys, commonly referred to as buttons. For instance, bid routing characters 24 may be the alphabetic characters “A” through “M” and offer routing characters 34 may be the alphabetic characters “N” through “Z.” However, the user may assign any keys of his/her choice including numbers or combination keys, e.g. <ALT>C. Alternatively, the montage row itself may perform the function of a bid or offer routing character by operating as an on-screen button which can be selected by a computer input device such as a mouse. However implemented, routing character keys may be assigned consistently to a particular montage row 18, 28. This enables the routing characters 36 to remain in a fixed, expected, location, thus developing a highly intuitive nature to the user interface.

Quantity keys 42 are keys or on-screen buttons that associate with different numbers of units to be traded. That is, each routing character key 36 in conjunction with each quantity key 42 define a transaction of a determined number of units of a determined tradable with a determined market marker at a determined price. Quantity keys 42 may be keyboard keys 58 such as numerals “1” through “0” or may be associated with on-screen keys often referred to as buttonsor menu choices. For example, among the quantity keys 42, the key bearing the numeral “1” may indicate a quantity of 100, “2” may indicate 200, “3” may indicate 300 and so forth.

Other keys, such as function keys on a keyboard may be used to define a quantity different from that associated with just the quantity key 42. For example, 1000 shares may be represented by the key “0” and 500 shares represented by the key “5” and pressing<Shift>0 5 could indicate a share quantity of 1500, which is 1000 added to 500.

In addition, function keys may be used to provide a multiplication function, perhaps being a multiplier of 10. By way of example<Shift>1 may indicate a share quantity of 10 times 100, e.g. 1000. “Function keys” as used in this application is intended to include keys F1-F12,<Shift>,<Alt>, <Ctrl>and other alphanumeric or non-alphanumeric keys.

In summary, each quantity key 42 in conjunction with each routing character key 36 define a transaction of a determined number of units of a determined tradable with a determined market participant at a determined price. “Quantity keys 42” and “routing character keys 36” may be single keys, keystroke sequences, and/or on screen buttons or commands activated by a mouse, keyboard or other computer input device.

The method of processing financial market information is provided with the steps of identifying a tradable in a montage window 60. A symbol 14 may be used to identify the tradable. The montage 60 may show various market participants 20, 30 for the tradable, prices per unit 22, 32 from each market participant 20, 30, and routing characters in a matrix 24, 34.

Each routing character 24, 34 associates with one market participant 20, 30 and one price 22, 32. Each routing character 24, 34 coordinates with a routing character key 36. Routing character keys 36 may be keyboard keys 58, perhaps each bearing an alphabetic character “A” through “Z.” Routing character keys 36 may be divided into bid routing character keys 38 and offer routing character keys 40. When a bid routing character is pressed the trade will be a sell and when an offer routing character is pressed the trade will be a buy. Alternatively, a function key may be pressed together with a bid routing character key 38 to indicate a purchase, or with an offer routing character key 40 to indicate a sell transaction.

Quantity keys 42 may each associate with a predetermined quantity. The quantity keys 42 may be keyboard keys 58, perhaps each bearing one numeric character “1” through “0”. For example, the quantity key bearing the numeral “1” may indicate a quantity of 100, “2” may indicate 200, “3” may indicate 300 and so forth.

A transaction may be defined by identifying the market participant 20, 30, the market participant's price per unit 22, 32 and the desired quantity via pressing a routing character key 36 and a quantity key 42. Once defined, a transaction may be immediately routed by the invention to an order management system, FIX engine, or to the chosen order destination directly or via some other intermediary. This may occur without additional user input to avoid time delays.

The software of the present invention may also automatically cancel the transaction if the market participant 20, 30 moves its bid or offer price 22, 32 before the transaction is routed and that market participant's new price is beyond an acceptable pre-defined price range. Further, the software may automatically adjust the price 22, 32 in the transaction if the market participant 20, 30 moves its price 22, 32 to a different level before the transaction is routed, so long as the market participant's new price is within an acceptable pre-defined price range.

In an alternative embodiment the method of processing financial market information may be provided with the steps of assigning data in a montage 60. The montage 60 may include montage rows 18, 28. Each montage row 18, 28 may display a market participant 20, 30 and price per unit of a tradable. Quantity keys 42 may be defined to having a quantity associated therewith. A transaction may be initiated via clicking a montage row 18, 28 to identify the chosen market participant and pressing a specific quantity key 42, or mouse clicking on an on-screen quantity button, while still maintaining the two-step order entry process. The on-screen quantity button refers to any software user interface that enables the user to select a quantity for the purposes of this invention.

Although the present invention has been described with reference to preferred embodiments, workers skilled in the art will recognize changes may be made in form and detail without departing from the spirit and scope of the invention.

I claim:

1) A financial market transaction device, comprising:
a computer, including a monitor displaying a symbol for a tradable, a bid side and an offer side, the bid side including a list of bid montage rows, each bid montage row including a bid market participant, a bid price and a bid routing character, the offer side including a list of offer montage rows, each offer montage row including an offer market participant, an offer price and an offer routing character;
routing character keys each corresponding with a member selected from the group consisting of bid routing characters and offer routing characters; and
quantity keys associated with different numbers of units to be traded, such that each routing character key in conjunction with each quantity key define a transaction of a determined number of units of a determined tradable with a determined market participant at a determined price.

2) The device of claim 1 wherein the bid and offer routing character keys are alphanumeric keyboard keys.

3) The device of claim 1 wherein the bid routing characters are selected from the group consisting of alphabetic characters A through M.

4) The device of claim 1 wherein the offer routing characters are selected from the group consisting of alphabetic characters N through Z.

5) The device of claim 1 wherein the bid and offer routing characters are selected from the group consisting of numeric characters 0 through 9.

6) The device of claim 1 wherein the quantity keys are keyboard keys associated with numerals selected from the group consisting of 0 through 9.

7) The device of claim 1 wherein the montage row is vertically oriented.

8) A method of processing financial market information, comprising:
identifying a tradable in a montage;
showing in the montage various market participants for the tradable, prices per unit from each market participant, and routing characters in a matrix, each routing character associating with one market participant and one price;
coordinating each routing character with a routing character key;
providing quantity keys, each key associated with a predetermined quantity; and
defining a transaction including the tradable, market participant, market participant's price per unit and the quantity via pressing a routing character key and a quantity key.

9) The method of claim 8 wherein the step of identifying describing, further comprises:
describing the tradable with a symbol.

10) The method of claim 8 wherein the routing character keys are keyboard keys each bearing one member selected from the group consisting of alphabetic characters A through Z.

11) The method of claim 8 wherein the routing character keys are keyboard keys each bearing one members selected from the group consisting of numeric characters 0 through 9.

12) The method of claim 8 wherein the quantity keys are keyboard keys each bearing one members selected from the group consisting of numeric characters 1 through 0.

13) The method of claim 8 wherein the quantity key bearing: the numeral 1 associates with a quantity of 100, the numeral 2 associates with a quantity of 200, the numeral 3 associates with a quantity of 300, the numeral 4 associates with a quantity of 400, the numeral 5 associates with a quantity of 500, the numeral 6 associates with a quantity of 600, the numeral 7 associates with a quantity of 700, the numeral 8 associates with a quantity of 800, the numeral 9 associates with a quantity of 900, and the numeral 0 associates with a quantity of 1000.

14) The method of claim 8 further comprising the step of:
routing the transaction to the chosen market participant.

15) The method of claim 14 further comprising the step of:
automatically canceling the transaction if the market participant moves its price before the transaction is routed and that market participant's new price is beyond an acceptable predetermined price range.

16) The method of claim 14 further comprising the step of:
automatically adjusting the price in the transaction if the market participant moves its price to a different level before the transaction is routed, and the market participant's new price is within an acceptable predefined price range.

17) The method of claim 8 further comprising the step of:
dividing routing character keys into bid routing character keys and offer routing character keys, bid routing character keys being associated with a sell, offer routing character keys being associated with an buy transaction.

18) The method of claim 8 further comprising the step of:
dividing routing character keys into bid routing character keys and offer routing character keys, bid routing character keys in conjunction with a function key being associated with a buy, offer routing character keys in conjunction with a function key being associated with an sell transaction.

19) The method of claim 8 wherein the quantity keys are additive.

20) The method of claim 8 further comprising the step of:
using function keys in conjunction with quantity keys to define a quantity different than that associated with just the quantity key.

21) The method of claim 20 further comprising the step of:
using function keys in conjunction with quantity keys to define a quantity which is a multiple of that associated with just the quantity key.

22) The method of claim 8 further comprising the step of:
using function keys in conjunction with an alphanumeric key to express routing character keys.

23) A method of processing financial market information, comprising:
assigning data in a montage, the montage including montage rows, each montage row including a market participant and price per unit of a tradable;
defining quantity keys, each key having a quantity associated therewith; and
initiating a transaction via using a computer input device to select a montage row, with its corresponding market participant, and then pressing a quantity key to indicate a quantity.

24) The method of claim 23 wherein the computer input device is a mouse.

25) A method of processing financial market information, comprising:
assigning data in a montage, the montage including montage rows, each montage row including a market participant and price per unit of a tradable;
defining on-screen quantity buttons, each button having a quantity associated therewith; and
initiating a transaction via using a computer input device to select a montage row, with its corresponding market participant, and then using a computer input device to select a quantity.

26) The method of claim 25 wherein the computer input device is a mouse.
